(19) United States
(12) Patent Application Publication
(10) Pub. No.: US 2026/0359243 A1
(43) Pub. Date: Nov. 12, 2026

(54) SECURE COMPUTING SYSTEM WITH UNIDIRECTIONAL DATA FLOW

(71) Applicant: Charles Dasher, Lawrenceville, GA (US)

(72) Inventor: Charles Dasher, Lawrenceville, GA (US)

(73) Assignee: RENDEER SYSTEMS LLC, Lawrenceville, GA (US)

(21) Appl. No.: 19/202,744

(22) Filed: May 8, 2025

(51) Int. Cl. G06F 13/38

(52) U.S. Cl. CPC G06F 13/38; G06F 2213/40

(57) ABSTRACT

A secure computing system enforces unidirectional data flow between untrusted and trusted processing environments over a high-speed serial interconnect. A data-diode circuit disposed on the interconnect includes a programmable switch that forwards only those transaction-layer packets whose requester identifier corresponds to the untrusted module and whose target identifier corresponds to the trusted module. Reverse-directed packets are dropped in hardware, ensuring one-way communication. Additional features include cryptographic authentication using replay counters and message authentication codes, eBPF-based in-kernel enforcement, and an access-control list specifying authorized traffic patterns. A bounded maintenance mode permits time-limited bidirectional access using a whitelist loaded by the trusted module. The system supports secure inference, isolation of model parameters, and automated shutdown of compromised components. Methods and non-transitory media implementing these security policies are also described.

### BACKGROUND

The present disclosure is generally directed towards hardware security for computing systems and, more particularly, to techniques that enforce unidirectional data flow between trusted and untrusted execution environments over packet-switched serial fabrics such as PCI Express.

### SUMMARY

With the emergence of multicore processors, sensor-rich edge devices, and pervasive packet-switched serial fabrics such as PCI Express, sensitive workloads are increasingly distributed between lower-assurance preprocessing domains and higher-assurance execution environments. Conventional software-based protections cannot guarantee strict one-way data transfer; protocol asymmetries, direct-memory-access capabilities, and covert channels leave sensitive parameters exposed to exfiltration or tampering.

The present disclosure describes a secure computing system that addresses these shortcomings through a hardware data-diode circuit positioned on a high-speed serial interconnect. A programmable switch within the circuit enforces an access-control list (ACL) and, in real time, forwards only memory-read, memory-write, I/O-read, I/O-write, configuration-read, and completion packets whose requester identifier corresponds to an untrusted processing module and whose target identifier corresponds to a trusted processing module. All traffic in the reverse direction is dropped in hardware, thereby eliminating leakage paths regardless of software state.

Some embodiments support a bounded maintenance mode in which temporary, controlled bidirectional access is permitted. Before entering this mode, the trusted module loads a cryptographic whitelist into the data-diode switch, specifying permissible requester IDs, target IDs, packet types, and address ranges. When the trusted module asserts a maintenance-enable signal and starts a countdown timer, the switch consults this whitelist instead of the default ACL. Only packets matching the whitelist are forwarded bidirectionally during the window. Upon timer expiry or policy violation, the switch reverts automatically to one-way mode, ensuring continued protection of the trusted domain.

Optional features include physical removal of reverse-direction receiver pairs, insertion of replay-protection counters and message authentication codes (MACs) into vendor-defined header fields, complementary input-output memory-management-unit policies, kernel-level traffic monitoring using extended Berkeley Packet Filter (eBPF) programs, and automated power shutdown of the untrusted module upon detection of a policy violation. The disclosure also includes a method of secure data processing and non-transitory computer-readable media storing firmware or configuration logic, thereby supporting both system architecture and operational deployment.

Maintenance operations such as firmware updates or diagnostics may require temporary bidirectional access. Before such a maintenance window opens, the trusted module loads a whitelist into the data-diode circuit, the whitelist identifying permissible requester identifiers, packet types, and address ranges. The whitelist is stored in one-time-write memory accessible only to the trusted module. When maintenance is initiated, a maintenance-enable signal is asserted and a countdown timer is activated. During this time window, the data-diode circuit permits bidirectional passage only for packets that match the whitelist; all others are dropped and logged. Upon expiration of the timer or detection of any unauthorized packet, the switch reverts to one-way mode and clears the maintenance state, thereby ensuring controlled, auditable access.

To meet low-latency requirements typical of sensor-driven workloads, the switch supports pipelined authentication and employs dual-bank buffering, enabling cryptographic validation to overlap with packet reception. This architecture sustains full bandwidth operation even during traffic bursts.

These features collectively provide hardware-level enforcement of one-way data flow, from system initialization through maintenance, while preserving performance and configurability in complex environments.

In accordance with one aspect of the disclosure, a secure computing system is provided. A first processing module, operating as an untrusted execution environment, generates outbound transaction-layer packets on a high-speed serial interconnect. Each packet carries a requester identifier corresponding to the untrusted module. A hardware data-diode circuit disposed on the interconnect compares each packet's metadata against an access-control list. If the packet matches authorized parameters, the circuit forwards it to a second processing module, operating as a trusted execution environment. Packets originating at the trusted module or failing the authorization check are dropped.

The access-control list is generated and managed by the trusted module and stored in the data-diode's configuration memory. During initialization, this list governs all packet forwarding decisions in hardware. When a maintenance window is initiated, the trusted module enables a temporary override using a whitelist stored in protected memory. Only packets that match this whitelist are forwarded in both directions. Unauthorized packets are dropped and logged. Upon completion or violation, the system automatically reverts to one-way operation.

### BRIEF DESCRIPTIONS OF THE DRAWINGS

The present disclosure is described in detail with reference to the following figures, which illustrate example embodiments of the systems and methods discussed herein. These drawings are provided for explanatory purposes and are not intended to be limiting. For clarity, elements may be simplified or not drawn to scale.

FIG. 1 shows a schematic diagram of a secure computing system that enforces unidirectional data flow between an untrusted module and a trusted module, in accordance with some embodiments of the disclosure.

FIG. 2 shows a sequence diagram of illustrative steps for secure data processing, including transmission, authentication, and inference steps, in accordance with some embodiments of the disclosure.

FIG. 3 shows a schematic representation of a transaction-layer packet format including authentication metadata, in accordance with some embodiments of the disclosure.

FIG. 4 shows a flowchart of a method for secure data processing with access control and authentication validation, in accordance with some embodiments of the disclosure.

FIG. 5 shows a hierarchical metadata structure used by the programmable interconnect switch to enforce access-control list policies, in accordance with some embodiments of the disclosure.

FIG. 6 shows a flowchart of maintenance mode operation that enables time-bounded bidirectional packet forwarding using a whitelist, in accordance with some embodiments of the disclosure.

FIG. 7 shows a flowchart of enforcement logic performed by an extended Berkeley Packet Filter (eBPF) program, including metadata inspection and automated response to policy violations, in accordance with some embodiments of the disclosure.

### DETAILED DESCRIPTION

The examples discussed herein are directed to systems and methods for enforcing unidirectional data flow between processing environments of differing trust levels. In some embodiments, the system comprises a computing platform having a first processing module configured as a trusted execution environment and a second processing module configured as an untrusted execution environment. The modules are interconnected via a high-speed serial interface that includes a data-diode circuit configured to physically and logically enforce one-way communication from the untrusted module toward the trusted module.

The secure computing system may be implemented in edge computing devices, industrial controllers, network appliances, sensor platforms, or embedded AI processors. The trusted execution environment may be isolated by hardware, software, or both, and may be tasked with performing sensitive inference, policy enforcement, encryption, or other high-assurance operations. The untrusted execution environment may interface with external networks, preprocess sensor data, demodulate satellite waveforms, or run less-sensitive workloads under relaxed trust constraints.

A data diode, as referred to herein, includes hardware and logic elements that ensure signal flow occurs only in one direction, typically from the untrusted module to the trusted module. This may be accomplished using access control lists (ACLs), link topologies that omit return paths, or programmable switches configured to filter packet types and identifiers. In some embodiments, packet-based interconnects such as PCI Express are extended to support replay protection and cryptographic validation using a vendor-defined header field.

The access control list is stored in on-chip memory accessible to a programmable interconnect switch and may include entries that match packet types, requester identifiers, target identifiers, or other protocol-level metadata.

Transactions that do not conform to the ACL policy are dropped by the switch. As used herein, an extended Berkeley Packet Filter (eBPF) program refers to a software routine that executes within the kernel space of the trusted processing module. The eBPF program may be configured to inspect metadata associated with each forwarded transaction, log packet-level details, and raise an interrupt in response to an ACL violation or authentication failure. In some embodiments, the eBPF program is attached to an interconnect interface and provides real-time visibility into forwarded traffic, optionally triggering automated enforcement logic such as isolation or shutdown of the untrusted module. Such an eBPF program may be used for real-time monitoring and logging of packet-level violations within the system.

A transaction-layer packet may include, among other fields, a requester ID, target ID, type or attributes, and a payload. In some embodiments, a vendor-defined field is used to encode a replay counter and a message authentication code (MAC) computed over the packet's contents. The MAC may be computed over at least a portion of the packet's header and payload using a shared secret or key which may be provisioned by the trusted side during initialization. These values are jointly validated by the trusted module to confirm the packet's authenticity and freshness before processing.

The systems and methods described herein are applicable to devices with strict isolation requirements, including but not limited to aerospace systems, defense platforms, industrial automation controllers, and autonomous sensing modules. They are especially well-suited for environments where inference results must not be exposed to external interfaces, or where regulatory or mission assurance constraints mandate hardware-based one-way communication enforcement.

The system may be implemented on a wide range of computing hardware, including printed circuit boards, system-on-chip devices, field-programmable gate arrays (FPGAs), and custom ASICs. Software instructions, access control tables, and policy logic may be stored in volatile or non-volatile memory. In some embodiments, a non-transitory computer-readable medium encodes instructions that configure the switch or perform authentication logic as described.

Technical advantages of the disclosed systems include hardware-level enforcement of trust boundaries, reduction of software attack surfaces, and protection of sensitive inference logic from reverse flows of information. The approach eliminates the need for complex firewall rules, microkernel partitioning, or cryptographic fencing in systems that require deterministic enforcement of one-way data paths.

In some embodiments, the programmable interconnect switch inserts authentication metadata into a vendor-defined header field of each packet that it forwards to the trusted processing module. The metadata may include a replay-protection counter and a cryptographic checksum used to verify the authenticity and integrity of the packet.

In addition to the MAC, each forwarded packet includes a replay-protection counter—a monotonically increasing value or sequence number. The trusted module maintains a record of previously seen counters to identify and discard packets that have been replayed or received out of order.

The programmable interconnect switch applies filtering rules based on packet metadata. These rules are stored in a structure referred to as an access-control list (ACL). As used herein, an ACL is a memory-resident data structure that encodes one or more conditions based on requester identifier, target identifier, packet type, or address range. The switch compares each received packet against the ACL to determine whether it should be forwarded or dropped.

In some embodiments, the access-control list is extended with a cryptographically protected maintenance whitelist. This whitelist defines a secondary set of rules that are consulted only during a bounded maintenance window. The trusted processing module may load the whitelist into a one-time-writable register bank located on the programmable interconnect switch. Each whitelist entry specifies a requester identifier, target identifier, packet type, and address range that is temporarily permitted during maintenance. When maintenance mode is activated, the trusted module asserts a maintenance-enable signal and starts a countdown timer. During the active window, the switch forwards only packets that match the whitelist; all others are dropped and logged. If the timer expires or an unauthorized packet is detected, the switch automatically disables maintenance mode and reverts to enforcing the baseline ACL policy. This mechanism enables controlled, auditable bidirectional access without compromising the system's unidirectional security guarantees.

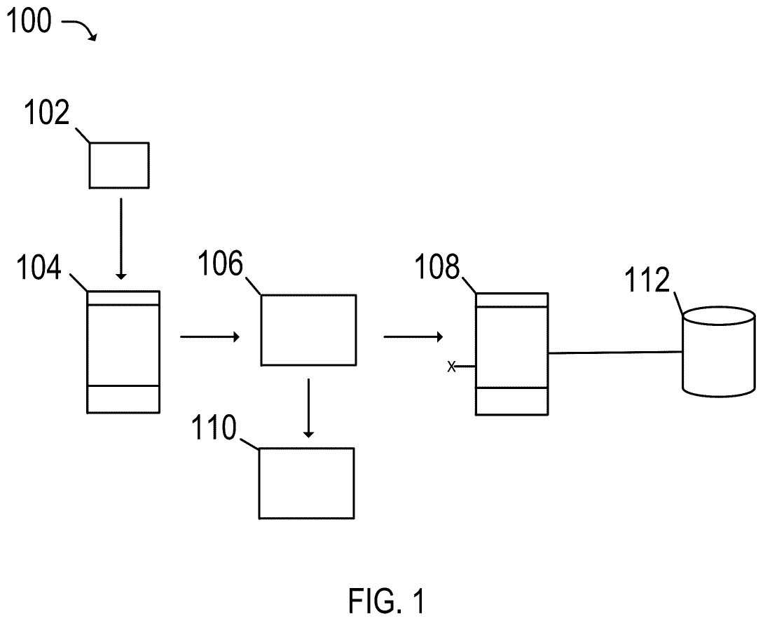

FIG. 1 illustrates a secure computing system 100 that receives sensor or network input at a first, untrusted processing module 104, forwards data through a data-diode circuit 106 toward a trusted processing module 108, and stores sensitive models and inference results in a secure store 112. Sensor data enters at source 102 and is delivered to the untrusted module 104, which performs preprocessing and transmits transaction-layer packets over a high-speed serial link toward the diode 106. Within the diode, an access control list 110 enforces unidirectional flow by forwarding only packets whose requester identifier corresponds to the untrusted module 104 and whose target identifier corresponds to the trusted module 108. Any packet in the reverse direction is blocked, as indicated by the stubbed line terminating in an “X.” The trusted module 108 authenticates forwarded packets, performs secure inference, and writes encrypted weight files and inference results to the secure store 112, which is addressable only by the trusted module. No data path exists from the untrusted module 104 to the secure store 112, and no packet path exists from the trusted module 108 back to the untrusted module 104, thereby enforcing a one-way security policy.

The system 100 of FIG. 1 corresponds to the secure computing system recited in claim 1. The first processing module 108 and second processing module 104 are interconnected by a high-speed serial interconnect incorporating a data-diode circuit 106. The programmable interconnect switch and associated access-control list 110 enforce the unidirectional data flow required by the claim. Secure inference results are written to the secure store 112, which is inaccessible to the untrusted module. Sensor input 102 supplies the untrusted module with external data.

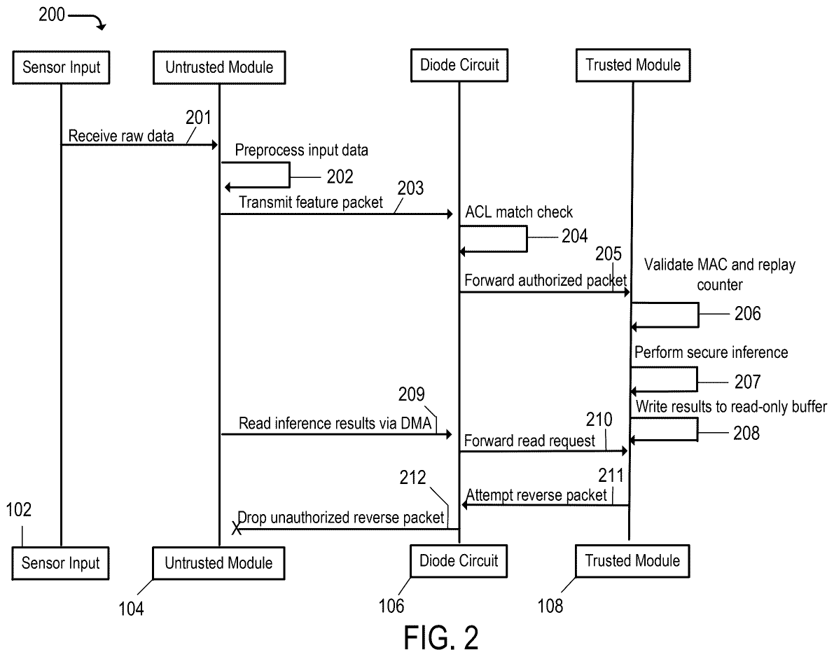

FIG. 2 shows a sequence diagram of illustrative steps for enabling secure data processing, in accordance with some embodiments. Process 200 begins when sensor input 102 provides raw data to untrusted module 104. At step 201, the untrusted module receives the raw data. At step 202, it preprocesses the input to generate feature data. The feature data is transmitted in transaction-layer packets at step 203 to diode circuit 106. The diode performs an ACL match check at step 204, and if the packet satisfies the ACL, it is forwarded to trusted module 108 at step 205. The trusted module validates the packet's MAC and replay counter at step 206. If valid, the trusted module performs inference at step 207 and writes results to a local buffer at step 208. At step 209, the untrusted module may attempt to read the result via DMA; the diode forwards this at step 210. If the trusted module initiates any reverse-directed packet, it is blocked at step 211 and discarded at step 212.

The sequence diagram of FIG. 2 illustrates operations consistent with the method recited in claim 11. Steps 201 through 209 correspond to method steps (a) through (e). Step 212 illustrates the unidirectional enforcement required by step (f).

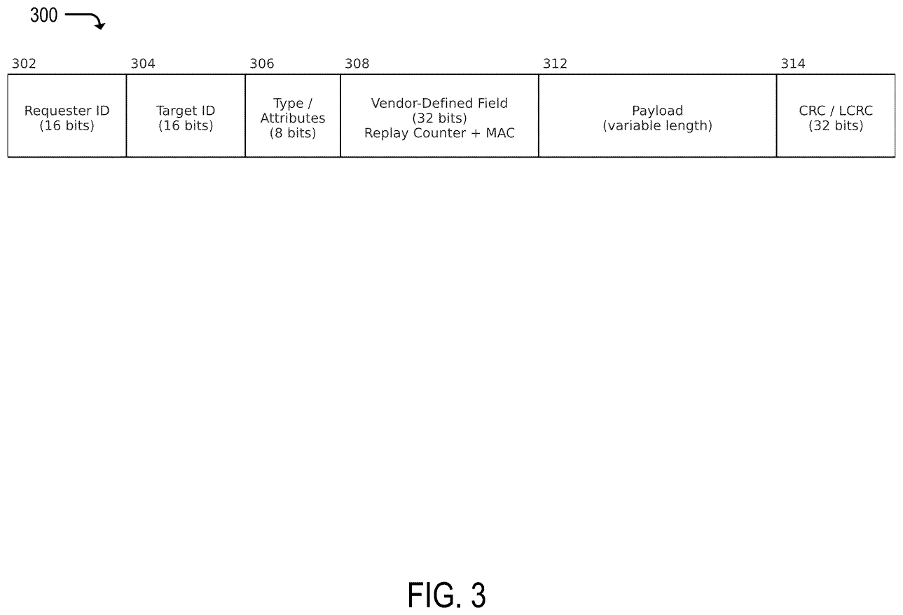

FIG. 3 shows a schematic diagram of a transaction-layer packet format 300. The packet includes a requester ID field 302, a target ID field 304, a type or attribute field 306, and a vendor-defined field 308. The vendor-defined field encodes authentication metadata, including a replay counter and a message authentication code (MAC) computed over a portion of the packet's header and payload. These values enable the trusted processing module to verify authenticity and freshness of the received packet. A payload field 312 carries application data, and a CRC or LCRC field 314 provides physical-layer integrity checking.

This packet format corresponds to the features recited in claims 3, 4, 14, and 15. The vendor-defined field 308 extends the header format to carry cryptographic integrity metadata. Fields 302 through 314 represent key packet elements used to enforce secure, unidirectional transfer and validate trust between modules.

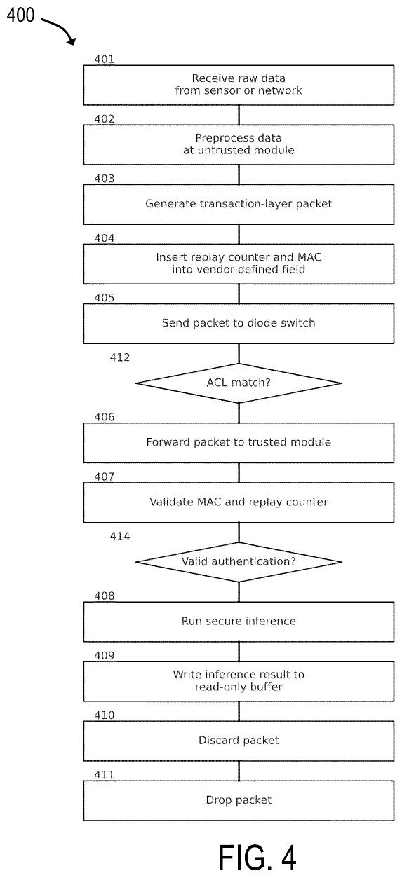

FIG. 4 shows a flowchart of secure data processing as process 400. At step 401, data is received from sensors or a network. The untrusted module preprocesses the input at step 402 and generates a transaction-layer packet at step 403. Replay and MAC metadata are inserted at step 404. The packet is transmitted at step 405. At decision point 412, the ACL is checked. If authorized, the diode forwards the packet at step 406, and the trusted module validates the MAC and counter at step 407. If the packet is authentic (414), inference is performed at step 408 and the result is stored in a read-only buffer at step 409. If the packet fails authentication or ACL checks, it is discarded at step 410 or dropped at step 411.

For clarity, the sequential operations recited in claim 11 are referred to herein using lettered step designations (a) through (g), corresponding respectively to each functional element of the method.

This flowchart further illustrates the method of claim 11. Step 401 corresponds to step (a), steps 402 through 405 to steps (b) and (c), steps 406 through 409 to steps (d) and (e), and steps 410 through 414 to the enforcement logic described in step (f).

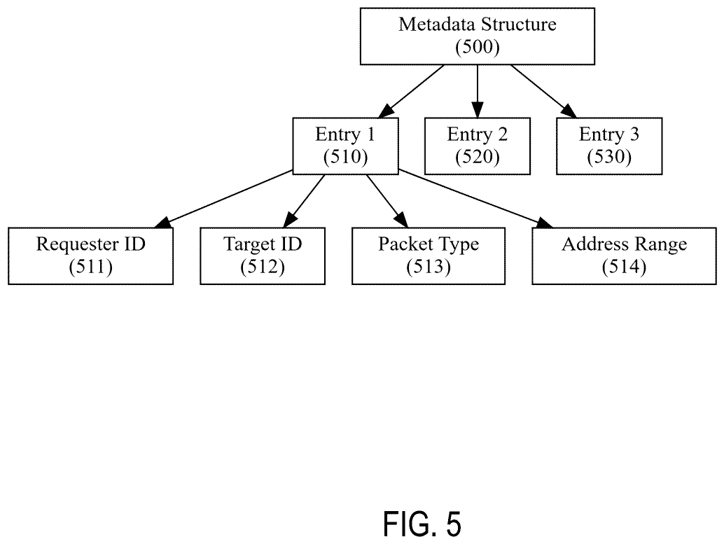

FIG. 5 illustrates a hierarchical metadata structure 500 used by the data-diode circuit to enforce access-control policies in accordance with some embodiments of the disclosure. The metadata structure 500 is stored in on-chip configuration memory accessible to a programmable interconnect switch and comprises a plurality of entries, shown here as entry 1 (510), entry 2 (520), and entry 3 (530). Each entry encodes a distinct access rule that governs whether a given transaction-layer packet is authorized for forwarding.

As shown, entry 1 (510) includes four fields: a requester ID field 511, a target ID field 512, a packet type field 513, and an address range field 514. The requester ID 511 identifies the source module permitted to initiate the packet, while the target ID 512 specifies the intended destination module. Packet type 513 indicates the category of transaction (e.g., memory read, memory write, I/O access), and address range 514 defines the permissible destination addresses associated with the transaction. Similar fields are present in other entries (520, 530), allowing the metadata structure to encode multiple allowed pathways.

During operation, the interconnect switch receives transaction-layer packets and consults metadata structure 500 to determine if the packet matches an authorized entry. If the requester ID, target ID, packet type, and address range align with one of the entries, the packet is forwarded; otherwise, it is dropped in hardware. In some embodiments, the metadata structure 500 is loaded only by the trusted processing module and may include read-only or one-time-write protections to prevent tampering.

This structure supports both the normal operating mode, in which unidirectional flow is enforced from the untrusted to the trusted module, and a restricted maintenance mode, during which a time-limited whitelist governs temporary bidirectional communication. In each case, metadata structure 500 ensures that only explicitly authorized transactions are permitted, maintaining strict isolation and enforcing hardware-based security boundaries.

The structure illustrated in FIG. 5 corresponds to the metadata referenced in claims 1, 2, 16, and 18. In particular, metadata structure 500 includes entries such as entry 510, which specify requester ID 511, target ID 512, packet type 513, and address range 514. These fields map directly to the conditions evaluated by the programmable interconnect switch during enforcement of the access-control policy described in the claims.

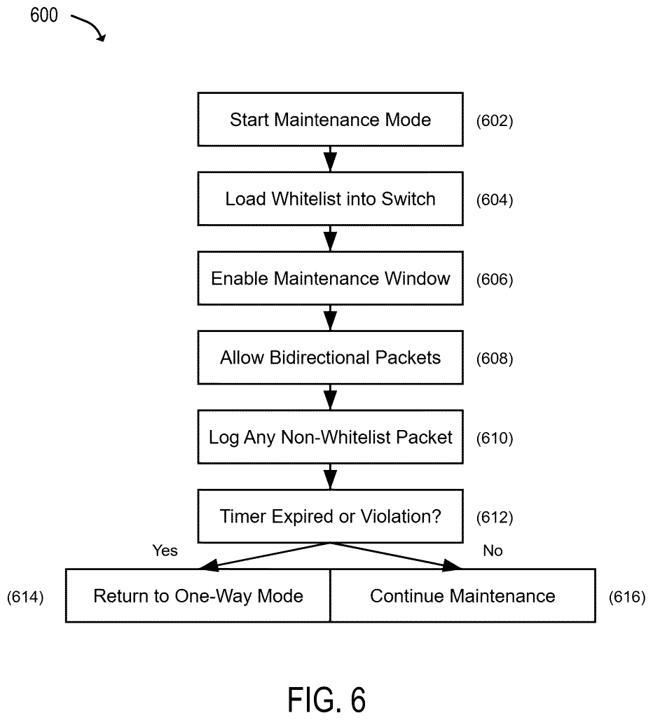

FIG. 6 illustrates Maintenance Mode Operation 600. At step 602, the trusted module loads a cryptographic whitelist into the data-diode circuit. Step 604 shows the assertion of a maintenance enable signal and start of a timer. At step 606, a packet is received and evaluated against the whitelist (step 608). If matched, it is forwarded at step 610. If not matched, it is blocked and logged at step 612. If a violation is detected, step 614 clears the maintenance state and reverts to one-way operation. If the timer expires normally (step 616), the system likewise reverts to its default unidirectional policy.

The maintenance workflow shown in FIG. 6 supports the time-bounded bidirectional access described in claim 16. In particular, steps 602 through 616 depict the process of enabling maintenance mode, loading a whitelist (604), allowing bidirectional packets (608), and terminating maintenance upon a violation or timer expiry (612), with the system returning to one-way mode at step 616. These operations correspond to the conditional access-control configuration and automatic reversion mechanism recited in the claim.

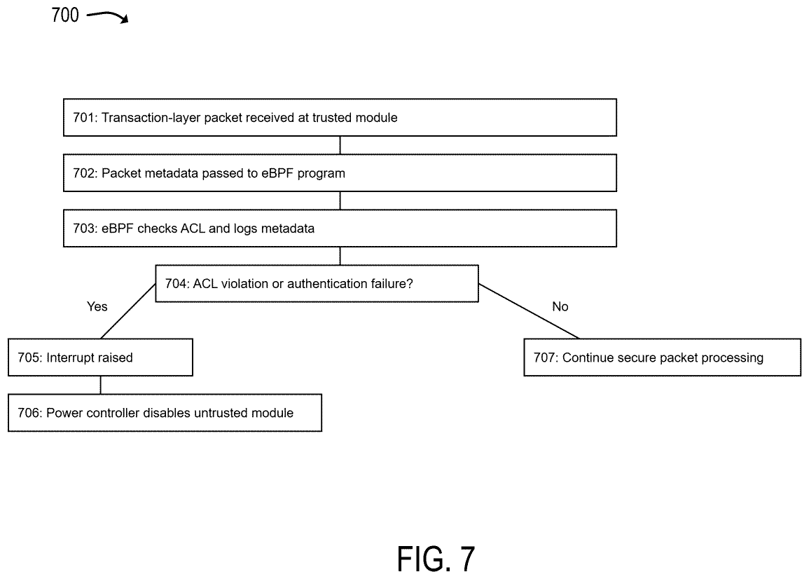

FIG. 7 shows a flowchart of an enforcement process 700 involving an extended Berkeley Packet Filter (eBPF) program. At step 701, a transaction-layer packet is received by the trusted processing module. At step 702, packet metadata is passed to an eBPF program executing in the kernel space of the trusted module. At step 703, the eBPF program inspects the metadata, performs access-control checks, and logs relevant information. A decision is made at step 704 to determine whether the packet violates any access-control list (ACL) rules or fails authentication. If a violation or failure is detected, step 705 raises an interrupt. Step 706 responds by instructing the power controller to disable the untrusted module. If no violation is detected at step 704, the system proceeds to step 707, allowing secure packet processing to continue. Process 700 provides real-time enforcement of security policies through in-kernel inspection and automated response mechanisms.

The enforcement process shown in FIG. 7 corresponds to the operations recited in claim 17. In particular, step 701 illustrates the reception of a transaction-layer packet at the trusted processing module, while steps 702 through 704 depict inspection of metadata by an eBPF program and evaluation against access-control policies. If an ACL violation or authentication failure is detected, steps 705 and 706 illustrate the responsive actions—raising an interrupt and triggering power disablement of the untrusted module. These steps collectively implement real-time enforcement logic as claimed, using in-kernel monitoring and hardware control to ensure system integrity.

In an example, a secure computing system may be deployed in an industrial environment where vibration sensors monitor the condition of rotating machinery. The sensors correspond to source 102 and are connected to an untrusted processing module 104 that performs preprocessing such as noise filtering, windowing, and feature extraction. The untrusted module then transmits feature vectors as transaction-layer packets across a high-speed serial interconnect to a trusted processing module 108. The interconnect includes a data-diode circuit 106 with a programmable switch and access control list 110 enforcing unidirectional flow from the untrusted module 104 to the trusted module 108.

The trusted processing module 108 performs neural network inference using encrypted weight files stored in a local secure store 112. The inference results —such as predictions of bearing wear or shaft misalignment—are retained within the trusted module and are not accessible by the untrusted module. If the untrusted module 104 attempts to initiate a reverse transaction or probe the address space of the trusted module, the data-diode circuit 106 blocks the packet. A kernel-resident eBPF program running on the trusted module inspects packet metadata and, upon detecting the violation, raises an interrupt that triggers the shutdown of the untrusted module by a power management controller (not shown).

This configuration ensures that inference results and model parameters remain protected, even in the presence of a compromised preprocessing environment. A technical advantage of this example is that of enforcing strict one-way data flow while enabling real-time analytics on high-throughput sensor data.

In another example, a secure computing system is used in a command relay device for remote-controlled robotics. The untrusted processing module 104 is exposed to an external network and receives real-time telemetry and control signals from a sensor or uplink source 102. It extracts command intent (e.g., a setpoint or trajectory vector), encapsulates this as feature data, and transmits it over the high-speed serial interconnect in one or more transaction-layer packets to the data-diode circuit 106.

Each packet includes a requester identifier field 302, a target identifier field 304, and authentication metadata inserted into a vendor-defined field 308, including a replay-protection counter and a message authentication code (MAC). The ACL 110 within the data-diode circuit is consulted to ensure the packet originates from the untrusted module 104 and targets the trusted module 108. If authorized, the diode forwards the packet to the trusted module, which validates the MAC and replay counter before accepting it.

Upon successful validation, the trusted processing module 108 reformats the command and writes it to a memory-mapped command buffer for dispatch. The untrusted module 104 cannot access this buffer, nor can it initiate any reverse-directed packet, as the data-diode circuit 106 enforces a one-way flow policy. If a replayed or malformed packet is received, it is discarded, and a log entry is created by the eBPF program.

This configuration allows real-time control commands to pass through a trusted sanitization layer before being enacted, while maintaining hardware-enforced isolation. A technical advantage of this example is the prevention of command spoofing or unauthorized actuator control through isolation and message authentication.

In a satellite-communications example, a satellite terminal such as a Starlink ground station supplies Digital Intermediate Frequency Interoperability (DIFI) frames to the untrusted processing module 104. The untrusted module demodulates, descrambles, and channelizes the incoming downlink to extract symbol vectors or spectral features. These features are packaged into transaction-layer packets and transmitted through data-diode circuit 106 in accordance with ACL 110. The trusted processing module 108 verifies the integrity of each packet using embedded authentication metadata and then applies an AI model to perform secure inference tasks such as emitter identification, link-quality scoring, or geolocation estimation. The AI model and associated parameters are stored in encrypted form within secure store 112 and are inaccessible to the untrusted side. Because the data-diode circuit enforces strict one-way data flow, the trusted module cannot be used to echo input data or reveal inference results, thereby preventing leakage of model behavior and maintaining isolation of sensitive processing logic.

The processes and systems described above are provided for illustrative purposes and are not intended to limit the scope of the disclosure. One skilled in the art will recognize that the steps, components, or logical arrangements discussed herein may be modified, omitted, reordered, combined, or supplemented without departing from the principles set forth. The features and functions described in connection with any one embodiment may be applied to other embodiments, and the examples or diagrams presented may be rearranged or integrated in different sequences or in parallel. Additionally, the described methods may be implemented in real-time systems and applied in conjunction with other architectures or use cases.

What is claimed is:

1. A system comprising:
a first processing module configured as a trusted execution environment;
a second processing module configured as an untrusted execution environment;
a high speed serial interconnect coupling the first and second processing modules; and
a data diode circuit including a programmable interconnect switch disposed on the serial interconnect,
the switch being configured to:
forward, over the serial interconnect, each transaction layer packet whose requester identifier corresponds to the second processing module and whose target identifier corresponds to the first processing module; and
drop, without forwarding, each transaction layer packet whose requester identifier corresponds to the first processing module;
thereby enforcing unidirectional data flow from the untrusted module toward the trusted module.

2. The system of claim 1, wherein the data-diode circuit comprises:
a link topology in which differential receive pairs on a link segment from the first processing module toward the second processing module are electrically open-circuited, thereby physically preventing reception of packets originating at the first processing module.

3. The system of claim 1, wherein the programmable interconnect switch is further configured to insert, into a vendor-defined header field of each forwarded packet:
a replay-protection counter, and
a truncated message-authentication code.

4. The system of claim 3, wherein the first processing module is further configured to:
validate the message-authentication code; and
discard any packet having an invalid or duplicate replay-protection counter.

5. The system of claim 1, wherein the first processing module comprises:
a first input-output memory-management unit programmed to:
map only read-only buffers associated with the serial interconnect; and
the second processing module comprises a second input-output memory-management unit programmed to:
deny direct-memory-access transactions targeting any address range owned by the first processing module.

6. The system of claim 1, further comprising:
an operating-system kernel driver executing on the first processing module, and
a kernel driver attaching an extended Berkeley Packet Filter program that
logs metadata of each forwarded packet, and
raises an interrupt upon detection of any packet that violates the access-control list.

7. The system of claim 6, further comprising:
a power-management controller configured to remove power from the second processing module upon receipt of the interrupt.

8. The system of claim 1, wherein the second processing module is further configured to perform preprocessing of raw sensor data to produce feature data; and
the first processing module is further configured to perform secure inference on the feature data, wherein the data-diode circuit prevents inference results from being transmitted to the second processing module.

9. The system of claim 1, wherein the high-speed serial interconnect is a packet-switched, lane-oriented serial fabric configured to employ differential signaling, flow-control credits, and transaction-layer packets.

10. The system of claim 1, wherein the programmable interconnect switch is a multi-port high-speed serial switch compliant with the packet-switched serial fabric, and
includes on-chip configuration memory that stores the access-control list.

11. The system of claim 1, wherein the access-control list further blocks configuration-write transactions whose requester identifier corresponds to the first processing module, except during a time-bounded maintenance window initiated by the first processing module, during which the interconnect switch:
consults a whitelist stored in configuration memory to permit only preauthorized transaction-layer packets in either direction; and
automatically reverts to blocking upon expiration of the timer or violation of the whitelist.

12. The system of claim 1, wherein the first processing module:
stores a neural-network weight file in encrypted, read-only non-volatile memory;
decrypts and executes the weight file locally during inference; and
wherein the access-control list exposes only read-only buffer regions for receiving tensor inputs,
thereby preventing the second processing module from accessing the weight file or invoking inference operations on the first processing module.

13. The system of claim 1, wherein:
the second processing module is configured to extract features from untrusted data for transmission to the first processing module, and
the first processing module comprises a hardware-accelerated tensor engine configured to process the extracted features.

14. The method of claim 1, wherein:
preprocessing the untrusted data comprises:
applying a neural network on the second processing module to extract features; and
performing secure computation comprises:
executing a second neural network on the first processing module using the extracted features.

15. A method comprising:
receiving, at a second processing module configured as an untrusted execution environment, untrusted data;
preprocessing the untrusted data at the second processing module to generate feature data;
transmitting, over a high speed serial interconnect, transaction layer packets comprising the feature data, the packets having:
requester identifiers corresponding to the second processing module, and
target identifiers corresponding to a first processing module configured as a trusted execution environment;
forwarding, by a programmable interconnect switch disposed on the serial interconnect, each packet whose requester and target identifiers match an access control list;
validating, at the first processing module, a message authentication code appended to each forwarded packet and
discarding any packet having an invalid or duplicate code;
performing secure computation on the feature data at the first processing module; and
blocking, by the programmable interconnect switch, each transaction layer packet whose requester identifier corresponds to the first processing module.

16. The method of claim 15, further comprising storing inference results in a result buffer located in a memory space of the first processing module, the buffer being inaccessible to the second processing module under an input-output memory management unit policy.

17. The method of claim 15, further comprising:
detecting, at the first processing module, a packet that violates the access control list;
raising, by an extended Berkeley Packet Filter program, an interrupt; and
removing power from the second processing module in response to the interrupt.

18. A non-transitory, computer readable medium having non-transitory, computer-readable instructions encoded thereon that, when executed by a programmable interconnect switch disposed on a high speed serial interconnect coupling a trusted processing module and an untrusted processing module, cause the switch to:
read a requester identifier and a target identifier from each received packet;
compare the identifiers with an access control list;
forward each packet whose requester identifier corresponds to the untrusted processing module and whose target identifier corresponds to the trusted processing module; and
drop each packet whose requester identifier corresponds to the trusted processing module or whose target identifier corresponds to the untrusted processing module.

19. The non-transitory, computer readable medium of claim 18, wherein the execution of the instructions further cause the switch to:
generate a replay protection counter for each forwarded packet;
compute a message authentication code over the packet header and payload; and
insert both values into a vendor defined header field before forwarding the packet.
